(19) United States
(12) Patent Application Publication
(10) Pub. No.: US 2005/0173556 A1
(43) Pub. Date: Aug. 11, 2005

(54) Coating dispensing nozzle

(76) Inventors: Kui-Chiu Kwok, Gurnee, IL (US); John F. Schaupp, Toledo, OH (US)

Correspondence Address: Lisa M. Soltis;Illinois Tool Works Inc., 3600 West Lake Avenue, Glenview, IL, 60025, US

(21) Appl. No.: 10/775,007

(22) Filed: Feb. 9, 2004

(51) Int. Cl. B05B 1/24

(52) U.S. Cl. 239/79; 239/85; 239/589

(57) ABSTRACT

A dispenser for dispensing pulverulent coating material includes an opening through which the pulverulent material is discharged and a conduit through which the pulverulent material is transported from a source to the opening. The conduit includes a section having a generally rectangular cross section transverse to the general direction of flow of the pulverulent material through the conduit.

### CROSS-REFERENCE TO RELATED APPLICATIONS

This application is related to U.S. Ser. No. 10/628,908, filed Aug. 29, 2003, and assigned to the same assignee as this application.

### FIELD OF THE INVENTION

This invention relates to dispensers for dispensing coating materials such as pulverulent coating material (hereinafter sometimes “coating powder” or “powder”) suspended in a gas stream, for example, a stream of air, from, for example, a fluidized powder bed. It is disclosed in the context of a dispenser (hereinafter sometimes a “gun”) for dispensing coating powder. However, it is believed to have utility in other applications as well.

### BACKGROUND OF THE INVENTION

Systems for dispensing coating materials are known. There are, for example, the systems illustrated and described in U.S. Patents: U.S. Pat. Nos. 3,536,514; 3,575,344; 3,698,636; 3,843,054; 3,913,523; 3,964,683; 4,037,561; 4,039,145; 4,114,564; 4,135,667; 4,169,560; 4,216,915; 4,360,155; 4,381,079; 4,447,008; 4,450,785; Re. 31,867; 4,520,754; 4,580,727; 4,598,870; 4,685,620; 4,788,933; 4,798,340; 4,802,625; 4,825,807; 4,921,172; 5,353,995; 5,358,182; 5,433,387; 5,720,436; 5,853,126; and, 6,328,224. There are also the devices illustrated and described in U.S. Patents: U.S. Pat. Nos. 2,759,763; 2,955,565; 3,102,062; 3,233,655; 3,578,997; 3,589,607; 3,610,528; 3,684,174; 4,066,041; 4,171,100; 4,214,708; 4,215,818; 4,323,197; 4,350,304; 4,402,991; 4,422,577; Re. 31,590; 4,505,430; 4,518,119; 4,726,521; 4,779,805; 4,785,995; 4,879,137; 4,890,190; and, 4,896,384; British Patent Specification 1,209,653; Japanese published patent applications: 62-140,660; 1-315,361; 3-169,361; 3-221,166; 60-151,554; 60-94,166; 63-116,776; 58-124,560; and 331,823 of 1972; and, French patent 1,274,814. There are also the devices illustrated and described in “Aerobell™ Powder Applicator ITW Automatic Division” and “Aerobell™ & Aerobell Plus™ Rotary Atomizer, DeVilbiss Ransburg Industrial Liquid Systems.” The disclosures of these references are hereby incorporated herein by reference. This listing is not intended to be a representation that a complete search of all relevant art has been made, or that no more pertinent art than that listed exists, or that the listed art is material to patentability. Nor should any such representation be inferred.

### DISCLOSURE OF THE INVENTION

According to an aspect of the invention, a dispenser for dispensing pulverulent coating material includes an opening through which the pulverulent material is discharged and a conduit through which the pulverulent material is transported from a source. A first section of the conduit adjacent the opening has a generally rectangular cross section transverse to the direction of flow of the pulverulent material through the first section.

Illustratively according to this aspect of the invention, the first section comprises a first expander section.

Further illustratively according to this aspect of the invention, the conduit comprises a first reducer section upstream in the flow of pulverulent material from the first expander section.

Illustratively according to this aspect of the invention, the lumen of the first expander section includes a first cross-sectional area at an inlet end thereof and a second cross-sectional area at an outlet end thereof. The cross sectional area of the lumen in the first expander section increases uniformly from the first cross-sectional area to the second cross-sectional area.

Illustratively according to this aspect of the invention, the first reducer section includes a generally rectangular cross section transverse to the direction of flow of the pulverulent material through the first reducer section.

Illustratively according to this aspect of the invention, the lumen of the first reducer section includes a third cross-sectional area at an inlet end thereof and a fourth cross-sectional area at an outlet end thereof. The cross sectional area of the lumen in the first reducer section decreases uniformly from the third cross-sectional area to the fourth cross-sectional area.

Illustratively according to this aspect of the invention, the conduit further includes a second reducer section including a lumen, and a second expander section including a lumen.

Illustratively according to this aspect of the invention, the second reducer section is provided in a first structural component and the second expander section is provided in a second structural component adapted to be selectively coupled to the first structural component. The apparatus further includes a seal member sealing the selective coupling between the first and second structural components.

Illustratively according to this aspect of the invention, the lumen of the second reducer section includes a second cross section at an outlet end thereof, the lumen of the second expander section includes a third cross section at an inlet end thereof, and the lumen of the seal member provides a transition from the second cross section to the third cross section.

According to another aspect of the invention, a dispenser for dispensing pulverulent coating material includes an opening through which the pulverulent material is discharged and a conduit through which the pulverulent material is transported from a source to the opening. The conduit includes a first reducer section and a first expander section. Cross sections through at least one of the first reducer section and first expander section generally transverse to the direction of pulverulent material flow through the at least one of the first reducer section and first expander section are generally rectangular.

Illustratively according to this aspect of the invention, cross sections through both the first reducer section and first expander section generally transverse to the direction of pulverulent material flow through the first reducer section and first expander section are generally rectangular.

Illustratively according to this aspect of the invention, the first reducer section includes a first cross-sectional area at an inlet end thereof and a second cross-sectional area at an outlet end thereof. The cross-sectional area of the first reducer section decreases uniformly from the first cross-sectional area to the second cross-sectional area.

Further illustratively according to this aspect of the invention, the first expander section includes a third cross-sectional area at an inlet end thereof and a fourth cross-sectional area at an outlet end thereof. The cross sectional area of the first expander section increases uniformly from the third cross-sectional area to the fourth cross-sectional area.

Further illustratively according to this aspect of the invention, the apparatus includes a second reducer section having a fifth cross-sectional area at an inlet end thereof and a sixth cross-sectional area at an outlet end thereof. The cross sectional area of the second reducer section decreases uniformly from the fifth cross-sectional area to the sixth cross-sectional area.

Further illustratively according to this aspect of the invention, the apparatus includes a second expander section having a seventh cross-sectional area at an inlet end thereof and an eighth cross-sectional area at an outlet end thereof. The cross sectional area of the second expander section increasing uniformly from the seventh cross-sectional area to the eighth cross-sectional area.

### BRIEF DESCRIPTION OF THE DRAWINGS

The invention may best be understood by referring to the following detailed description and accompanying drawings which illustrate the invention. In the drawings:

FIG. 1 illustrates a partly longitudinal sectional side elevational, partly block diagrammatic view of a system incorporating the invention;

FIG. 2 illustrates a longitudinal sectional side elevational view of a detail of the system illustrated in FIG. 1;

FIG. 3 illustrates an end elevational view of the detail illustrated in FIG. 2, taken generally along the section lines 3-3 of FIG. 2;

FIG. 4 illustrates a longitudinal sectional side elevational view of a detail of the system illustrated in FIG. 1;

FIG. 5 illustrates an end elevational view of the detail illustrated in FIG. 4, taken generally along the section lines 5-5 of FIG. 4;

FIG. 6 illustrates a longitudinal sectional side elevational view of a detail of the system illustrated in FIG. 1;

FIG. 7 illustrates an end elevational view of the detail illustrated in FIG. 6, taken generally along the section lines 7-7 of FIG. 6;

FIG. 8 illustrates a longitudinal sectional side elevational view of a detail of the system illustrated in FIG. 1;

FIG. 9 illustrates an end elevational view of the detail illustrated in FIG. 8, taken generally along the section lines 9-9 of FIG. 8;

FIG. 10 illustrates a longitudinal sectional side elevational view of a detail of the system illustrated in FIG. 1;

FIG. 11 illustrates an end elevational view of the detail illustrated in FIG. 10, taken generally along section lines 11-11 of FIG. 10; and,

FIG. 12 illustrates a longitudinal sectional side elevational view of an alternative detail to the detail illustrated in FIGS. 10-11.

### DETAILED DESCRIPTIONS OF ILLUSTRATIVE EMBODIMENTS

As used in this application, terms such as “electrically conductive” and “electrically non-insulative” refer to a broad range of conductivities electrically more conductive than materials described as “electrically non-conductive” and “electrically insulative.” Terms such as “electrically semiconductive” refer to a broad range of conductivities between electrically conductive and electrically non-conductive. Terms such as “front,” “back,” “up,” “down,” and the like, are used only to describe illustrative embodiments, and are not intended as limiting.

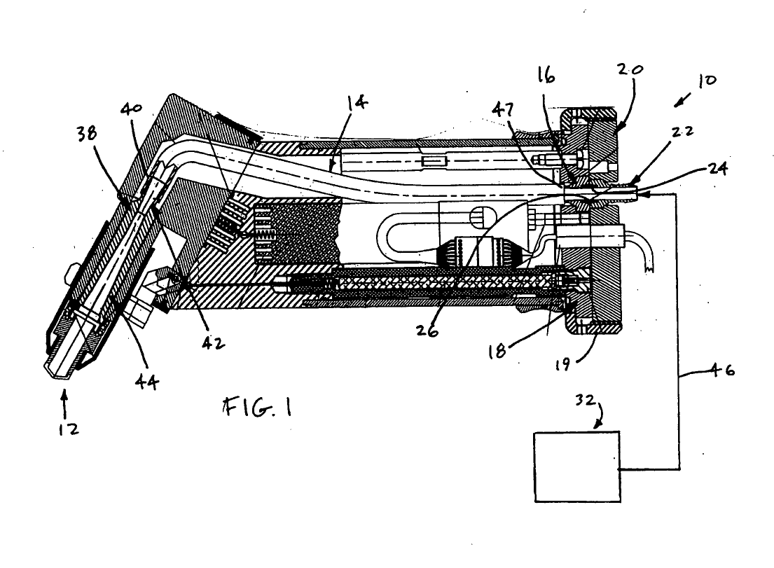

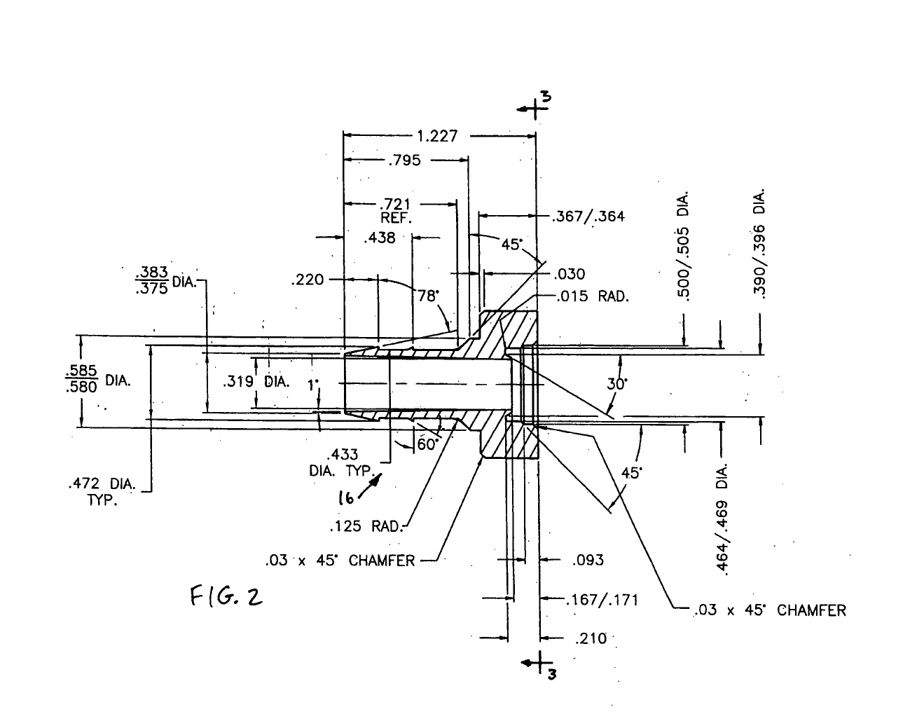

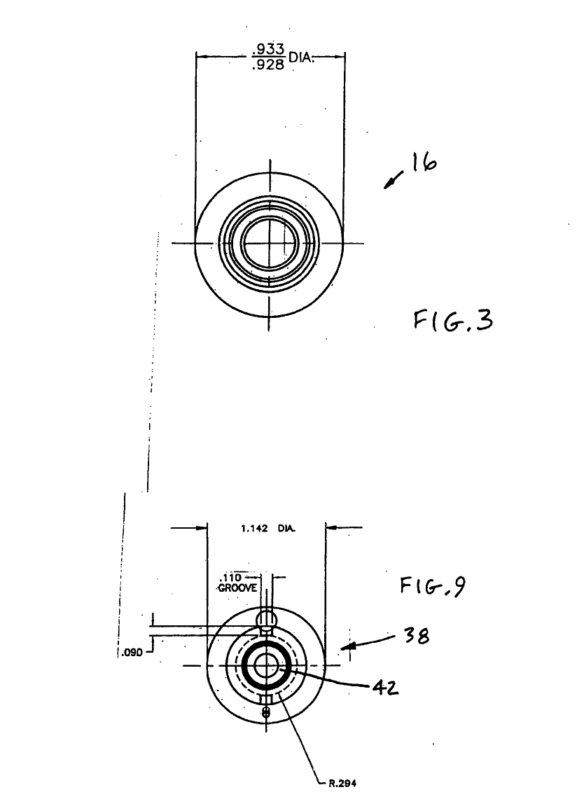

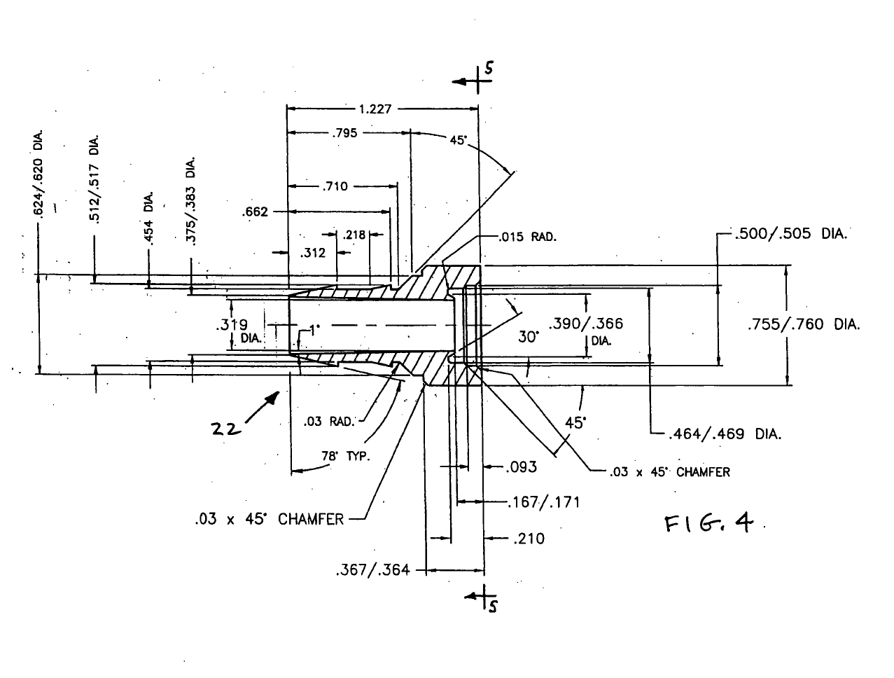

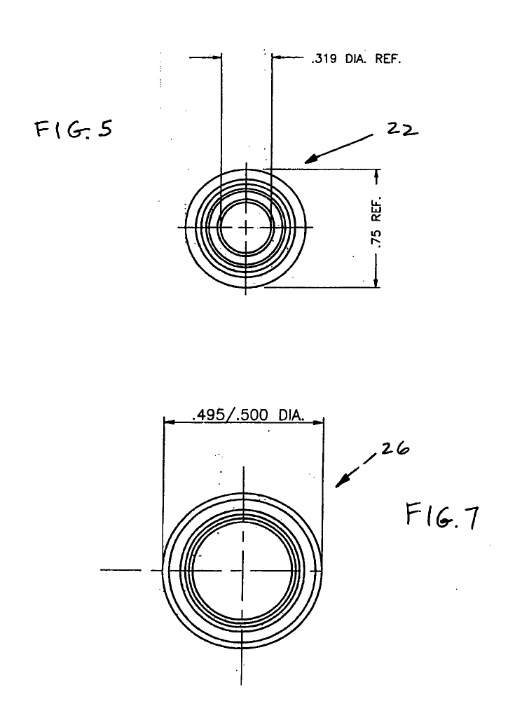

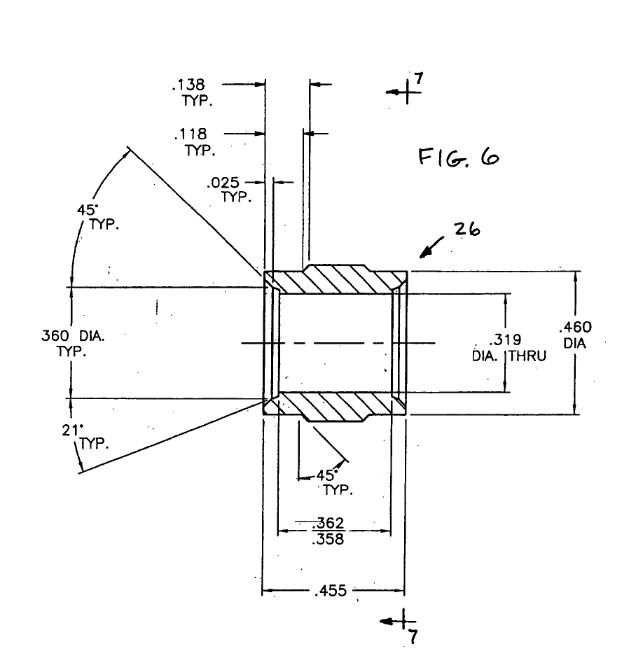

The drawings illustrate a powder gun 10 of the general type of, for example, an RPG-2 dual head robot powder gun model 78772 available from ITW GEMA Automotive Systems, ITW Automotive Finishing Group, 48152 West Road, Wixom, Mich. 48393. Referring to FIG. 1, gun 10 includes two side-by-side nozzles 12, each of which is coupled through a respective powder delivery tube 14 to a respective inside-the-gun 10 powder hose barbed fitting 16 (see FIGS. 2-3) mounted in a passageway provided therefor in a robot powder gun rear plate 18. Robot powder gun rear plate 18 is coupled by a threaded robot plate retaining ring 19 to a robot powder gun adapter plate 20 having a mating passageway provided with two robot plate powder hose barbed fittings 22 (see FIGS. 4-5). Each robot plate powder hose barbed fitting 22 cooperates with a respective powder hose barbed fitting 16 to define a groove 24 for receiving a respective powder hose fitting seal 26 (see FIGS. 6-7).

Each robot plate powder hose barbed fitting 22 illustratively includes a lumen which is circular in cross-section transverse to the direction of flow of powder therethrough. The diameter of the circular cross-section decreases linearly from a diameter of about 0.375 inch (about 9.5 mm.) to a diameter of about 0.319 inch (about 8 mm.) over a length of about 1.06 inches (about 2.7 cm.). Each powder hose barbed fitting 16 illustratively includes a lumen which is circular in cross-section. The diameter of the circular cross-section increases linearly from a diameter of about 0.319 inch (about 8 mm.) to a diameter of about 0.375 inch (about 9.5 mm.) over a length of about 1.06 inches (about 2.7 cm.). Fittings 16, 22 illustratively are constructed from 15-20% glass-filled Delrin 570® brand acetal resin. The lumen through seal 26 illustratively has a constant inside diameter of about 0.319 inch (about 8 mm.). Seal 26 illustratively is constructed from low density polyethylene.

This construction provides a low profile seal assembly 22, 26, 16 that results in reduced powder accumulation on and around the seal 26. The seal 26 is nested between the two barbed fittings 16, 22. The fittings 16, 22 cooperate to define the groove 24 which accommodates the seal 26. The seal 26 is compliant. When the seal 26 is oriented between the two barbed fittings 16, 22 and compressed by coupling robot powder gun rear plate 18 and robot powder gun adapter plate 20 together, the seal 26 presents a relatively low profile in the lumen 28 of the powder delivery tube 14, which reduces powder buildup. At the same time, the compression of the seal 26 between the two barbed fittings 16, 22, coupled with the configurations of the lumens of the fittings 16, 22, and the internal dimensions of the seal 26, create a first converging/diverging section in the flow path of the powder from a powder source 32. The source 32 may be one of any of a number of known types such as, for example, a fluidized bed of the general type illustrated and described in U.S. Pat. No. 5,768,800. A powder supply hose 46 extends from powder source 32 through a robot arm (not shown) to the end of which robot powder gun adapter plate 20 is mounted. A proximal end 47 of powder delivery tube 14 is coupled to powder hose barbed fitting 16.

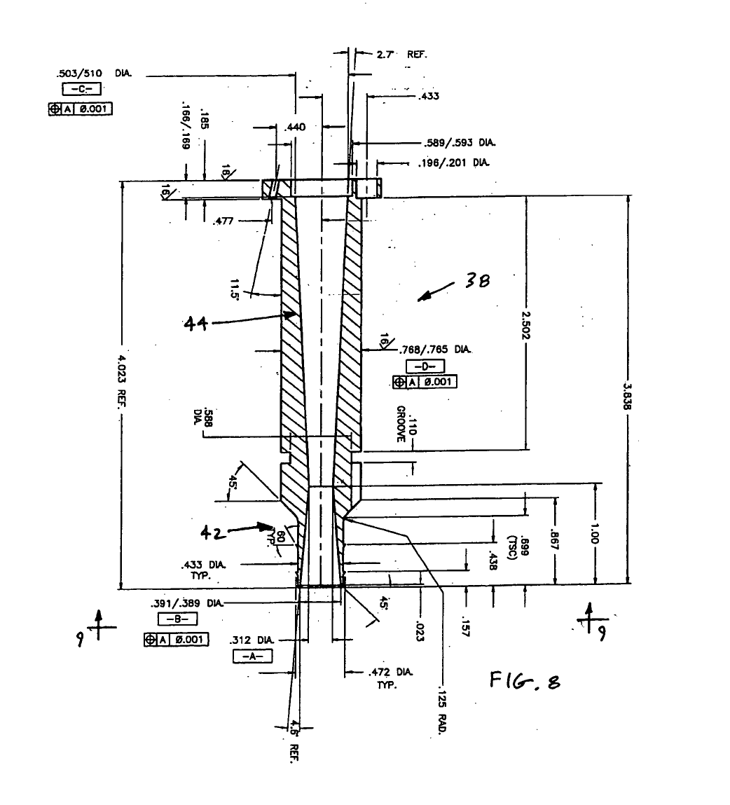

Referring to FIGS. 8-9, a second flow restrictor 38 is coupled between the remote end 40 of powder delivery tube 14 and nozzle 12. Second flow restrictor 38 includes a reducing section 42 and an expanding section 44. Illustratively, the lumen of reducing section 42 is circular in cross-section. Illustratively, the diameter of the lumen of reducing section 42 decreases linearly from a diameter of about 0.391 inch (about 1 cm.) to a diameter of about 0.312 inch (about 8 mm.) in a length of about 1 inch (about 2.5 cm.). Illustratively, the lumen of expanding section 44 is circular in cross-section. Illustratively, the diameter of the lumen of expanding section 44 increases linearly from the about 0.312 inch (about 8 mm.) diameter to a diameter of about 0.503 inch (about 1.3 cm.) in a length of about 2.834 inches (about 7.2 cm.).

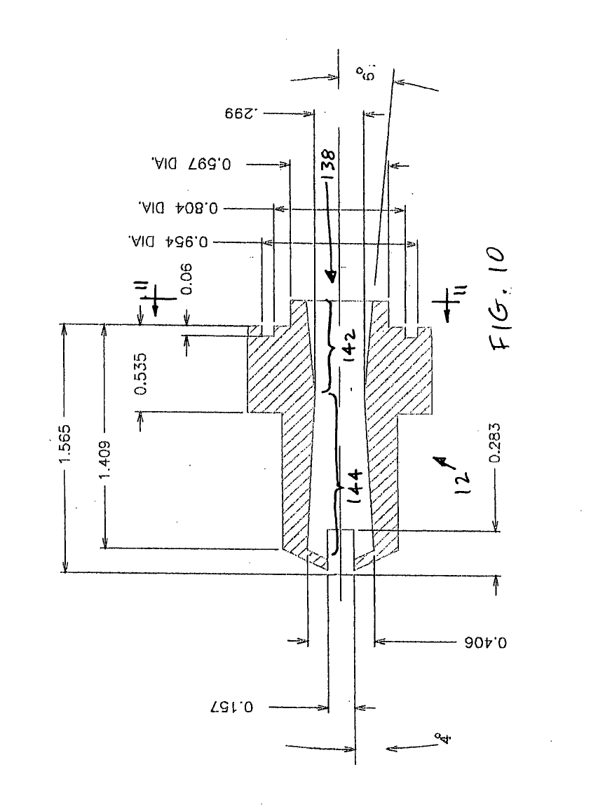

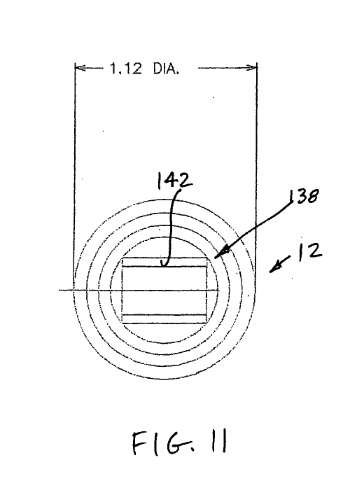

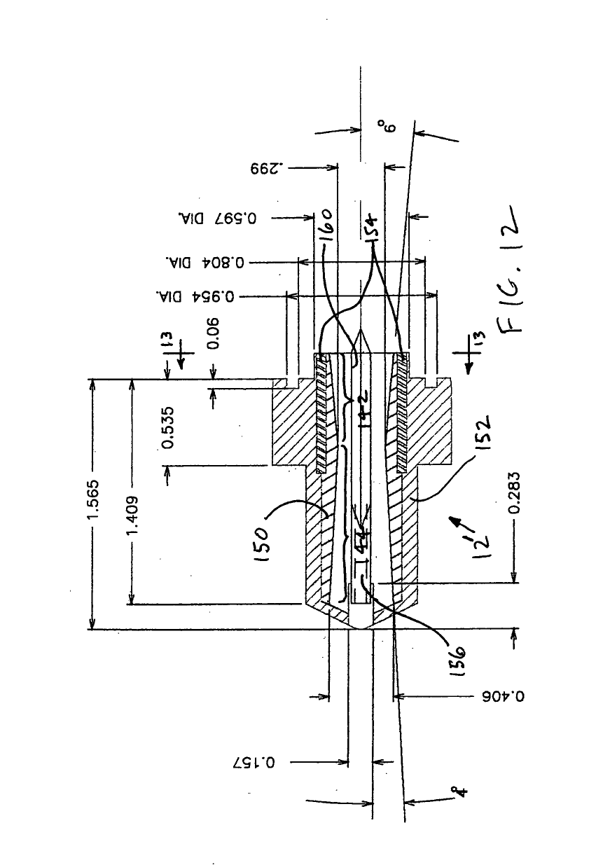

Referring to FIGS. 10-11, a third flow restrictor 138 is incorporated into the nozzle 12. Third flow restrictor 138 includes a reducing section 142 and an expanding section 144. The lumens of reducing section 142 and expanding section 144 are generally rectangular in cross-section. Illustratively, the lumen of reducing section 142 decreases linearly in dimensions from about 0.5 inch (about 1.25 cm.) by about 0.424 inch (about 1 cm.) to dimensions of about 0.5 inch (about 1.25 cm.) by about 0.299 inch (about 0.75 cm.) in a length of about 0.6 inch (about 1.5 cm.). Illustratively, the lumen of expanding section 144 increases linearly in dimensions from about 0.5 inch (about 1.25 cm.) by about 0.299 inch (about 0.75 cm.) to dimensions of about 0.5 inch (about 1.25 cm.) by about 0.406 inch (about 1 cm.) in a length of about 1 inch (about 2.5 cm.), with the about 0.5 inch (about 1.25 cm.) dimension of the reducing section 142 and the about 0.5 inch (about 1.25 cm.) dimension of the expanding section 144 being oriented the same way. Referring to FIG. 12, reducer section 142 and expander section 144 may be embodied in a resin, for example, polytetrafluoroethylene, sleeve 150 that is inserted into a nozzle 12′ housing 152 and pinned in place there using two locating pins 154. Gun 10 can further be provided with a charging electrode in a vane 156 which is inserted into slots 160 provided therefor in the sidewall of sleeve 150.

The reducer and expander sections 22, 42, 142; 16, 44, 144 are believed to provide flow profiles that reduce the powder buildup inside nozzle 12. Powder buildup is generally to be avoided in powder dispensing systems, because accumulated powder has a tendency to slough or “flake” off and be transported in the carrier gas (usually compressed air) stream to an article to be coated by the powder. This can cause a defect in the powder coating on the article. It is also believed that the generally rectangular cross section expander section 44 and reducer section 42 enhance laminar flow of the carrier gas-borne powder. This is believed to result in a more uniform dispersal of the powder in the carrier gas stream.

Twists and turns in powder supply hose 46 and powder delivery tube 14 may adversely affect flow parameters of the powder particles suspended in the transporting gas. First and second converging/diverging sections 22, 26, 16 and 42, 44 constrict the flow and then permit the flow to expand at a controlled rate to mitigate such adverse effects on flow parameters. Powder delivery tube 14 illustratively has a length of about 10.25 inches (about 26 cm.) and an inside diameter of about 0.375 inch (about 1 cm.) Powder delivery tube 14 illustratively is constructed from Tygothane® brand polyurethane. Flow restrictor 38 illustratively is constructed from 15-20% glass filled Delrin 570® brand acetal resin.

While the illustrated flow restrictors 16, 22, 26, 38 and 138 have linearly varying reducing and expanding section cross-sections, other configurations are, of course, possible. For example, the longitudinal section of the side wall of one or more of the reducing and/or expanding sections may be other than a straight line. For example, the longitudinal section of the side wall of one or more of the reducing and/or expanding sections may be an exponential curve, parabolic curve, hyperbolic curve, elliptic curve, circular curve, and so on.

The two converging/diverging sections 22, 26, 16 and 42, 44 are in the powder stream. It is believed that the two converging/diverging sections 22, 26, 16 and 42, 44 realign the powder particles so that the powder cloud downstream of the converging/diverging sections 22, 26, 16 and 42, 44 is somewhat more homogeneous. The powder is then presented to the nozzle 12, 12′. It is believed that the generally somewhat rectangular cross sectional shape 144 of the nozzle 12, 12′ shapes the powder stream into a somewhat more homogeneous, generally rectangular shape. The generally somewhat rectangular cross sectional shape 144 of the nozzle is believed to enhance flow. It is believed that in a circular cross section configuration conduit, there will less powder distributed near the wall of the conduit than with the rectangular cross section configuration 144. In the circular cross section configuration, the bulk of the powder will be toward the center of the conduit, and less toward the wall. It is believed that with the rectangular cross section 144, the powder is spread more uniformly across the rectangular section 144. In nozzles 12′ incorporating a center vane 156, at the exit of the nozzle 12′, as the two streams come together, they collide as they tend to fill the vane 156's “shadow” at the exit. If the powder density on the two sides of the vane 156 is unequal, the powder cloud that exits the nozzle 12′ may not be uniform. Any variation in the density of the powder stream exiting the nozzle 12′ may adversely affect the ability to achieve an even film “build” on the substrate being coated. A significant attributes of a coating dispensing system is its ability to provide uniform, controllable film thickness. Too thick of a coating can result in coating defects, and, by definition, results in waste material, increasing coating cost. Too thin of a coating can adversely affect coating appearance and function.

1. A dispenser for dispensing pulverulent coating material, the dispenser including an opening through which the pulverulent material is discharged and a conduit through which the pulverulent material is transported from a source, a first section of the conduit adjacent the opening having a cross section transverse to the direction of flow of the pulverulent material through the first section, the cross section of the first section being generally rectangular.

2. The apparatus of claim 1 wherein the first section comprises a first expander section.

3. The apparatus of claim 2 further comprising a first reducer section upstream in the flow of pulverulent material from the first expander section.

4. The apparatus of claim 2 wherein the lumen of the first expander section includes a first cross-sectional area at an inlet end thereof and a second cross-sectional area at an outlet end thereof, the cross sectional area of the lumen in the first expander section increasing uniformly from the first cross-sectional area to the second cross-sectional area.

5. The apparatus of claim 3 wherein the first reducer section includes a cross section transverse to the direction of flow of the pulverulent material through the first reducer section, the cross section of the first reducer section also being generally rectangular.

6. The apparatus of claim 5 wherein the lumen of the first reducer section includes a third cross-sectional area at an inlet end thereof and a fourth cross-sectional area at an outlet end thereof, the cross sectional area of the lumen in the first reducer section decreasing uniformly from the third cross-sectional area to the fourth cross-sectional area.

7. The apparatus of claim 3 wherein the first reducer section includes a cross section transverse to the direction of flow of the pulverulent material through the first reducer section, the cross section of the first reducer section also being generally rectangular.

8. The apparatus of claim 1 wherein the conduit includes a seal member providing a lumen, a first member including a second reducer section including a lumen and a first feature and a second member including a second expander section including a lumen and a second feature, the first and second features cooperating to define a space for accommodating the seal member between the second reducer section and the second expander section.

9. The apparatus of claim 1 wherein the conduit further includes a second reducer section including a lumen, and a second expander section including a lumen.

10. The apparatus of claim 9 wherein the second reducer section is provided in a first structural component and the second expander section is provided in a second structural component adapted to be selectively coupled to the first structural component, and further including a seal member sealing the selective coupling between the first and second structural components.

11. The apparatus of claim 10 wherein the lumen of the second reducer section includes a second cross section at an outlet end thereof, the lumen of the second expander section includes a third cross section at an inlet end thereof, and the lumen of the seal member provides a transition from the second cross section to the third cross section.

12. A dispenser for dispensing pulverulent coating material, the dispenser including an opening through which the pulverulent material is discharged and a conduit through which the pulverulent material is transported from a source to the opening, the conduit including a first reducer section, a first expander section, cross sections through at least one of the first reducer section and first expander section generally transverse to the direction of pulverulent material flow through the at least one of the first reducer section and first expander section being generally rectangular.

13. The apparatus of claim 12 wherein the first reducer section includes a first cross-sectional area at an inlet end thereof and a second cross-sectional area at an outlet end thereof, the cross-sectional area of the first reducer section decreasing uniformly from the first cross-sectional area to the second cross-sectional area.

14. The apparatus of claim 13 wherein the first expander section includes a third cross-sectional area at an inlet end thereof and a fourth cross-sectional area at an outlet end thereof, the cross sectional area of the first expander section increasing uniformly from the third cross-sectional area to the fourth cross-sectional area.

15. The apparatus of claim 12 wherein the first expander section includes a first cross-sectional area at an inlet end thereof and a second cross-sectional area at an outlet end thereof, the cross sectional area of the first expander section increasing uniformly from the first cross-sectional area to the second cross-sectional area.

16. The apparatus of claim 12 further including a second reducer section having a first cross-sectional area at an inlet end thereof and a second cross-sectional area at an outlet end thereof, the cross sectional area of the second reducer section decreasing uniformly from the first cross-sectional area to the second cross-sectional area.

17. The apparatus of claim 16 further including a second expander section having a third cross-sectional area at an inlet end thereof and a fourth cross-sectional area at an outlet end thereof, the cross sectional area of the second expander section increasing uniformly from the third cross-sectional area to the fourth cross-sectional area.

18. The apparatus of claim 12 wherein cross sections through both the first reducer section and first expander section generally transverse to the direction of pulverulent material flow through the first reducer section and first expander section being generally rectangular.
